(19) United States
(12) Patent Application Publication
(10) Pub. No.: US 2026/0254816 A1
(43) Pub. Date: Aug. 27, 2026

(54) SYSTEMS AND DEVICES FOR MODULAR AND MULTI-PROCESSOR COMPUTING WITH TIERED ISOLATION AND SECURITY AND METHODS THEREOF

(71) Applicant: Stephen S Blackwell, Fort Worth, TX (US)

(72) Inventor: Stephen S Blackwell, Fort Worth, TX (US)

(21) Appl. No.: 19/552,992

(22) Filed: Feb. 27, 2026

Related U.S. Application Data
(60) Provisional application No. 63/764,052, filed on Feb. 27, 2025.

(51) Int. Cl. H04L 9/40

(52) U.S. Cl. CPC H04L 63/10

(57) ABSTRACT

A computing system for reducing propagation of a compromise between different computing activities. The system includes a plurality of processing environments, including a first processing environment having a first processor coupled to a first memory and a second processing environment having a second processor coupled to a second memory. The system includes a selection controller configured to selectively couple a plurality of shared resources to a selected processing environment such that the selected processing environment is enabled to utilize the plurality of shared resources while at least one non-selected processing environment is restricted from utilizing one or more of the shared resources. The plurality of processing environments is associated with different protection profiles including different isolation profiles or different security profiles. The system maintains protection of a second activity executed in the second processing environment when a compromise associated with a first activity occurs in the first processing environment.

### CROSS-RFERENCE TO RELATED APPLICATIONS

The present application claims priority to U.S. Prov. App. Ser. No. 63/764,052, filed on Feb. 27, 2025, titled “DUAL PROCESSOR SYSTEM FOR NETWORK ACCESS,” the entirety of which is incorporated herein by reference for all purposes.

### TECHNICAL FIELD

The present disclosure relates generally to network access systems, and more particularly to computing devices configured for isolating computing activities to reduce propagation of a compromise.

### BACKGROUND

Computing devices are routinely used to perform a wide range of activities that vary significantly in sensitivity and risk. For example, a user may access financial accounts, manage confidential business information, communicate through email or messaging platforms, browse general websites, and interact with social media services using the same computing device. These activities are often performed in close temporal proximity, and in many cases are performed during a single user session in which the computing device remains connected to one or more networks, including the internet. As a result, modern computing devices are routinely exposed to both sensitive workflows and higher exposure workflows within ordinary day-to-day usage patterns.

Connectivity to networks, particularly the internet, creates a persistent exposure surface for computing devices. Users may encounter malicious websites, malicious links, malicious advertisements, malicious downloads, and malicious messages, as well as exploitation attempts directed toward browsers, plugins, drivers, operating systems, and other software components. Even when users exercise caution, compromise can occur due to vulnerabilities in software, configuration errors, supply chain issues, credential theft, and social engineering. Such compromise may result in unauthorized access to data, unauthorized execution of code, installation of malware, or other security events. In some cases, an initial compromise may be subtle, may not be immediately detected, and may allow further unauthorized activity to occur over time.

A variety of security tools and practices exist to mitigate these risks. Examples include password policies, multi-factor authentication, antivirus software, firewalls, intrusion detection tools, encryption tools, access control policies, and software update mechanisms. While these approaches can be useful, they often depend on correct configuration, correct user behavior, and timely patching of vulnerabilities. In addition, many security measures are implemented at the software level and may be circumvented by sufficiently advanced attacks, particularly attacks that exploit previously unknown vulnerabilities, exploit privileged components, or exploit weaknesses in supply chains. As computing systems become more complex and more interconnected, managing security risks in a reliable and predictable manner remains a continuing technical challenge.

Accordingly, there is a continuing need for improved computing system architectures that enhance resiliency against compromise in network-connected environments. There is also a continuing need for approaches that reduce the practical impact of compromise events on users conducting sensitive activities on computing devices, particularly in environments where users also perform routine, higher exposure activities using the same computing device.

### BRIEF SUMMARY

The present disclosure achieves technical advantages as systems, methods, and computer-readable storage media that provide functionality for reducing propagation of a compromise between different computing activities executed within a computing system. In particular embodiments, a system may operate to provide a plurality of processing environments, including at least a first processing environment and a second processing environment, where each of the plurality of processing environments includes at least a respective processor operably coupled to at least a respective memory. The system may further operate to provide a selection controller configured to selectively couple a plurality of shared resources to a selected processing environment of the plurality of processing environments such that the selected processing environment is enabled to utilize the plurality of shared resources while at least one non-selected processing environment is restricted from utilizing at least a network interface resource. The system may further apply different protection profiles to different processing environments, such that compromise associated with a first activity executed within a first processing environment is less likely to propagate to a second activity executed within a second processing environment.

In embodiments, the system of embodiments may be configured to provide a dual-processor embodiment in which an online processor configured with a first operating system and a primary processor configured with a second operating system are selectively connectable to shared peripherals and a network interface via a processor switch. In some embodiments, the system of embodiments may be configured to provide a modular computing embodiment in which a host computer receives a plurality of computing modules, including a banking module, a social media module, and a general-purpose module, where each of the plurality of computing modules includes its own processor and memory and wherein a module selector is configured to control access of the plurality of computing modules to shared resources including a display, a keyboard, a mouse, and a network. In embodiments, the system of embodiments may be configured to provide tiered isolation and security configurations for the plurality of computing modules, enabling stronger protection for higher tier modules and more convenient operation for lower tier modules. In embodiments, the system of embodiments may be configured to operate in real-time or near-real-time, enabling switching between processing environments and controlled access to shared resources during user operation.

The advantageous result of the present disclosure includes several technical improvements over conventional computing systems that execute mixed-risk activities within a single shared execution environment. For example, the disclosed system's functionality to segregate different computing activities into different processing environments and to selectively couple shared resources to a selected processing environment may significantly reduce propagation of compromise from a first activity to a second activity. By configuring different processing environments with different protection profiles, including different isolation profiles and different security profiles, the system may reduce the likelihood that a compromise associated with a higher exposure activity results in exposure of sensitive credentials, sensitive session data, and other sensitive information associated with a highly sensitive activity.

Another technical improvement provided by the system of embodiments includes the system's automated approach to controlling access to shared resources in a manner that limits concurrent exposure of multiple processing environments to untrusted network activity. While conventional systems may permit multiple applications and processes to share a common network interface, common peripherals, and common host resources concurrently, the disclosed system may impose a deterministic control layer that selectively couples shared resources to a selected processing environment while restricting at least one non-selected processing environment from utilizing at least the network interface resource. This approach may greatly increase resiliency of a computing system by reducing a blast radius of compromise and by enabling continued protected operation of a higher protection processing environment even when a lower protection processing environment and or host resources become compromised.

Thus, it will be appreciated that the technological solutions provided herein, and missing from conventional computing systems that rely primarily on software-only sandboxing and or monolithic execution environments, are more than a mere application of a known manual security practice to a computerized environment. Rather, the present disclosure includes functionality to implement a technical compartmentalization and resource mediation architecture that replaces or supplements existing approaches that lack structural separation and deterministic coupling control over shared resources. In doing so, the present disclosure goes well beyond a mere application of a manual process to a computer. Accordingly, the claims herein necessarily provide a technological solution that overcomes a technological problem associated with propagation of compromise between different computing activities executed within a computing system.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of reducing propagation of a compromise between different computing activities. It is a further object of the disclosure to provide a system for reducing propagation of a compromise between different computing activities. These and other objects are provided by the present disclosure, including at least the following embodiments.

In one particular embodiment, a method of reducing propagation of a compromise between different computing activities is provided. The method includes providing a plurality of shared resources and providing a plurality of processing environments. In embodiments, the plurality of processing environments includes at least a first processing environment including at least a first processor operably coupled to at least a first memory and associated with a first protection profile, and a second processing environment including at least a second processor operably coupled to at least a second memory and associated with a second protection profile different from the first protection profile. The method further includes selectively coupling the plurality of shared resources to a selected processing environment of the plurality of processing environments such that the selected processing environment is enabled to utilize the plurality of shared resources while at least one non-selected processing environment of the plurality of processing environments is restricted from utilizing one or more of the plurality of shared resources, and executing a first activity in the first processing environment while the plurality of shared resources is selectively coupled to the first processing environment. In embodiments, in response to executing the first activity in the first processing environment, a compromise associated with the first activity occurs. The method also includes executing a second activity in the second processing environment while maintaining protection of the second activity at least in part by one or more of: the selective coupling performed by the selection controller and the second protection profile associated with the second processing environment.

In another embodiment, a system for reducing propagation of a compromise between different computing activities is provided. The system comprises a plurality of shared resources and a plurality of processing environments. In embodiments, the plurality of processing environments includes at least a first processing environment including at least a first processor operably coupled to at least a first memory, and a second processing environment including at least a second processor operably coupled to at least a second memory. The system also includes a selection controller operably coupled to the plurality of shared resources and to the plurality of processing environments. In embodiments, the selection controller is configured to selectively couple the plurality of shared resources to a selected processing environment of the plurality of processing environments such that the selected processing environment is enabled to utilize the plurality of shared resources while at least one non-selected processing environment of the plurality of processing environments is restricted from utilizing one or more of the plurality of shared resources. In embodiments, the plurality of processing environments is configured to be associated with different protection profiles relative to at least one other processing environment of the plurality of processing environments, such that a first protection profile associated with the first processing environment is different from a second protection profile associated with the second processing environment. In embodiments, the computing system is configured such that, responsive to a compromise associated with a first activity executed in the first processing environment of the plurality of processing environments, execution of a second activity in a second processing environment of the plurality of processing environments remains protected at least in part by the selective coupling performed by the selection controller and by the different protection profiles of the plurality of processing environments.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims, if any. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary computing system configured as a dual-processor system and configured with capabilities and functionality for compartmentalized computing activities through isolated computing environments in accordance with embodiments of the present disclosure.

FIG. 2 shows a flow diagram illustrating an example operational flow of a computing system configured as a dual-processor system and configured with capabilities and functionality for compartmentalized computing activities through isolated computing environments in accordance with embodiments of the present disclosure.

FIG. 3 is a block diagram of an exemplary system configured as a modular system and configured with capabilities and functionality for compartmentalized computing activities through isolated computing environments in accordance with embodiments of the present disclosure.

FIG. 4 is a block diagram illustrating the isolation and security configuration of a system configured with capabilities and functionality for compartmentalized computing activities through isolated computing environments in accordance with embodiments of the present disclosure.

FIG. 5 is a block diagram illustrating an example operational scenario of a system configured with capabilities and functionality for compartmentalized computing activities through isolated computing environments in accordance with embodiments of the present disclosure.

FIG. 6 shows a high-level flow diagram of operation of a system configured for reducing propagation of a compromise between different computing activities in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this jurisdiction.

Various embodiments of the present disclosure are directed to devices, systems, and/or methods for implementing computing systems that may be configured to enable a user to conduct computing activities while reducing a likelihood that a compromise associated with one activity propagates to another activity. In embodiments, a computing system may be configured to provide compartmentalization of computing activities by separating the computing activities across different processing environments and by controlling access to shared resources (e.g., shared peripherals and shared network resources) such that a selected processing environment is provided access to the shared resources while another processing environment is restricted from access to the shared resources. The computing system of embodiments may be configured to enable routine activities (e.g., general browsing, social media activity, email activity, and other routine activities) to be conducted in a manner that reduces exposure of restricted activities (e.g., banking activity, account management activity, confidential business activity, and/or other restricted activities), such as by isolating the restricted activities within a processing environment that is configured with stronger isolation and stronger security than a processing environment used for routine activities.

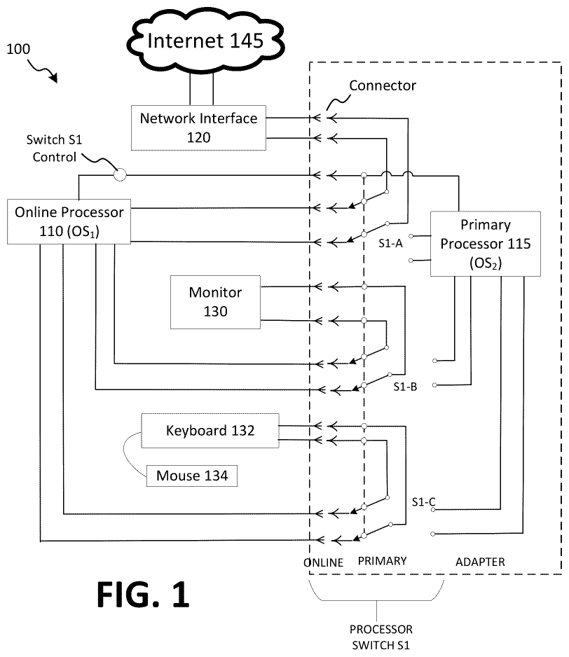

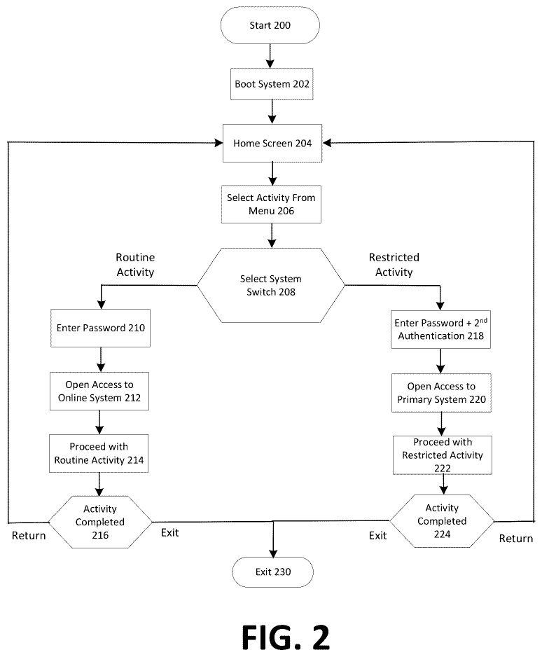

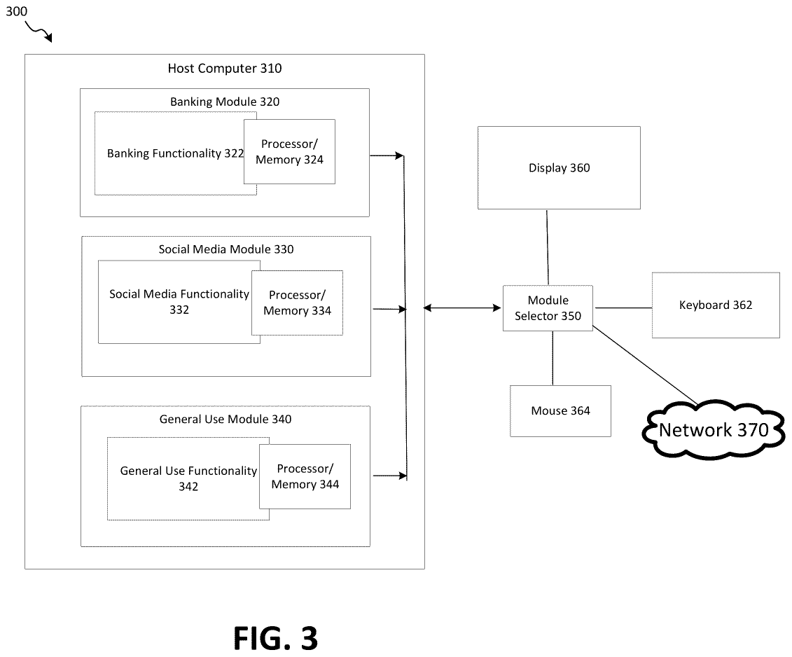

In embodiments, a system implemented in accordance with embodiments of the present disclosure may be configured with a dual-processor configuration and/or with a modular computing configuration. The dual-processor configuration will be described with respect to FIGS. 1-2. In embodiments, the dual-processor configuration may include an online processor 110 and a primary processor 115, each configured with a respective operating system, where the online processor 110 and the primary processor 115 may be selectively connected to shared resources (e.g., the network interface 120, the monitor 130, the keyboard 132, and the mouse 134) via a processor switch S1. The modular computing configuration will be described with reference to FIGS. 3-5. In embodiments, the modular computing configuration may include a system 300 including a host computer 310 and a plurality of computing modules (e.g., the banking module 320, the social media module 330, and the general use module 340), where each of the plurality of computing modules may include its own processor and memory and may be configured as a self-contained execution environment. In embodiments, the system 300 may include a module selector 350 configured to control access of the plurality of computing modules to shared resources (e.g., the display 360, the keyboard 362, the mouse 364, and the network 370). In embodiments, the dual-processor embodiment may be understood as a non-limiting embodiment that illustrates a subset of the broader modular computing concepts described herein, and the modular computing embodiment is not limited to only two processors and may include any number of computing modules.

In embodiments, the computing system 100 and the system 300 may be configured such that the separation between processing environments is not merely logical, but may further include structural separation and enforced boundaries that limit communications and limit resource sharing between different processing environments. In embodiments, such enforced boundaries may include physical separation, logical separation, firmware-enforced separation, hardware-backed separation, cryptographic separation, or any combination thereof. In embodiments, one or more of the processing environments described herein may be configured with different access protocols, including different authentication requirements, different encryption requirements, different policy requirements, and different restrictions on access to shared resources. Such differences in access protocol may be configured to reduce a likelihood that unauthorized access to one processing environment results in unauthorized access to another processing environment.

In embodiments, and as described in further detail below with reference to FIGS. 3-5, the modular computing configuration may be configured to apply different combined isolation and security profiles to different computing modules, such as by configuring a first computing module with a first isolation level and a first security level and configuring a second computing module with a second isolation level and a second security level different than the first isolation level and the first security level. In embodiments, the different combined isolation and security profiles may be selected to balance ease of use, cost, and security, among other factors. In embodiments, a higher isolation level and a higher security level may be more costly and may be less convenient to use (e.g., due to additional authentication steps), but may provide stronger protection, while a lower isolation level and a lower security level may be less costly and may be more convenient to use, but may be more vulnerable. In embodiments, the disclosed architectures and configurations may enable a user to assign a sensitive activity (e.g., banking activity) to a higher isolation and higher security computing module while assigning a routine activity (e.g., social media activity) to a lower isolation and lower security computing module, such that a compromise associated with the routine activity is less likely to expose the sensitive activity.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network.

FIG. 1 is a block diagram of an exemplary computing system 100 configured as a dual-processor system and configured with capabilities and functionality for compartmentalized computing activities through isolated computing environments in accordance with embodiments of the present disclosure. As shown, computing system 100 is illustrated as a dual-processor system, including an online processor 110 and a primary processor 115 that are selectively connectable to one or more shared resources of the computing system 100. In embodiments, the online processor 110 may be configured with a first operating system OS1, and the primary processor 115 may be configured with a second operating system OS2. In embodiments, the online processor 110 may be configured to support execution of routine activity, and the primary processor 115 may be configured to support execution of restricted activity. Restricted activity may include activity associated with confidential information or activity associated with higher risk if compromised.

In embodiments, the computing system 100 may be configured to reduce a likelihood that a compromise associated with routine activity performed by the online processor 110 results in exposure of restricted activity performed by the primary processor 115 by selectively limiting access of the online processor 110 and the primary processor 115 to shared resources such that only a selected one of the online processor 110 and the primary processor 115 is operably connected to at least one shared resource at a given time.

In embodiments, one or more of online processor 110 and primary processor 115 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of a processor may comprise code segments (e.g., software, firmware, and/or hardware logic) executable in hardware, such as a processor, to perform the tasks and functions described herein. In yet other embodiments, a processor may be implemented as a combination of hardware and software. In some embodiments, one or more of online processor 110 and primary processor 115 may may be communicatively coupled to a memory.

In embodiments, the memory may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. The memory may comprise a processor readable medium configured to store one or more instruction sets (e.g., software, firmware, etc.) which, when executed by a processor (e.g., one or more of online processor 110 and primary processor 115), perform tasks and functions as described herein.

As shown, the computing system 100 may include a network interface 120 that may be configured to connect to the internet 145. As also shown, the computing system 100 may include a monitor 130, a keyboard 132, and a mouse 134 that may be configured as shared peripherals accessible by the online processor 110 and the primary processor 115. In embodiments, the computing system 100 includes a processor switch S1 that may be configured to selectively connect the network interface 120, the monitor 130, the keyboard 132, and the mouse 134 to either the online processor 110 or the primary processor 115. In embodiments, the processor switch S1 includes switch contacts S1-A, S1-B, and S1-C that are configured to cooperatively operate to switch the connectivity of respective signal lines and return lines associated with the network interface 120, the monitor 130, the keyboard 132, and the mouse 134 between the online processor 110 and the primary processor 115. In embodiments, the processor switch S1 is configured such that when the online processor 110 is connected to the network interface 120 and the shared peripherals, the primary processor 115 is disconnected from at least the network interface 120, and when the primary processor 115 is connected to the network interface 120 and the shared peripherals, the online processor 110 is disconnected from at least the network interface 120.

In embodiments, the online processor 110 may be part of a main system motherboard of the computing system 100. In embodiments, the primary processor 115 may be included on a printed circuit board that may be configured as an adapter or card insertable into the computing system 100. In some embodiments, the printed circuit board may be associated with the processor switch S1 and may include connector functionality configured to connect the primary processor 115 to the monitor 130, the keyboard 132, the mouse 134, and the network interface 120 through the switch contacts S1-A, S1-B, and S1-C.

In embodiments, the processor switch S1 may include an ONLINE PRIMARY ADAPTER region (as illustrated in FIG. 1), where the ONLINE PRIMARY ADAPTER region may be configured to support switching between an online configuration associated with the online processor 110 and a primary configuration associated with the primary processor 115. In embodiments, the processor switch S1 may be operably controlled by switch S1 control, and the switch S1 control may be configured to receive user input, operating system input, policy input, or any combination thereof to control which of the online processor 110 and the primary processor 115 is connected to the shared resources.

In embodiments, the processor switch S1 may be implemented as a mechanical switch assembly, an electronic switch assembly, a semiconductor switch assembly, an integrated circuit switch assembly, or any combination thereof. In embodiments, the processor switch S1 may be implemented as a multi-station switch assembly that is configured to support selective switching among more than two processors, such that the dual-processor embodiment illustrated in FIG. 1 is a non-limiting example. In embodiments, the processor switch S1 may be configured such that the monitor 130, the keyboard 132, and the mouse 134 may be reused across the online processor 110 and the primary processor 115 without requiring duplication of peripheral hardware, while still providing controlled separation between the online processor 110 and the primary processor 115 with respect to network access via the network interface 120.

In embodiments, the processor switch S1 may be configured as a switch assembly that is structured to provide selective connectivity between a plurality of shared resources and a plurality of processors. For example, the processor switch S1 may be configured to selectively connect the network interface 120, the monitor 130, the keyboard 132, and the mouse 134 to either the online processor 110 or the primary processor 115 by switching respective signal and return conductors associated with such shared resources. In embodiments, the processor switch S1 may include a plurality of switch contacts, including the switch contacts S1-A, the switch contacts S1-B, and the switch contacts S1-C, where the switch contacts S1-A, the switch contacts S1-B, and the switch contacts S1-C may be configured to switch connectivity for respective shared resources or respective sets of conductors associated with the shared resources.

In embodiments, the processor switch S1 may be configured such that the switching operation occurs synchronously across multiple conductor pairs, such that a selected processor is connected to the shared resources while another processor is disconnected from at least one of the shared resources, including, in embodiments, disconnected from the network interface 120.

In embodiments, the processor switch S1 may be configured as a multi-station switch assembly. In embodiments, a multi-station switch assembly may include a switch assembly having more than two selectable positions, states, or stations, where each selectable position may correspond to a different processor or a different processing environment.

In embodiments, while FIG. 1 illustrates a dual-processor embodiment including the online processor 110 and the primary processor 115, the processor switch S1 may be configured to include additional stations to support additional processors beyond the online processor 110 and the primary processor 115. For example, additional stations may be implemented by adding additional sets of switch contacts that are synchronously switchable with the switch contacts S1-A, the switch contacts S1-B, and the switch contacts S1-C. In embodiments, such additional stations may enable the computing system 100 to be scalable, such that the computing system 100 may be configured with three processors, four processors, or more than four processors, each selectively connectable to the network interface 120 and the shared peripherals via the processor switch S1.

In embodiments, the processor switch S1 may be implemented as a mechanical switch assembly, such as a rotary switch assembly, a multi-throw switch assembly, a multi-pole switch assembly, or any combination thereof, where a mechanical switching element may physically route electrical connections between the shared resources and the selected processor. In embodiments, the processor switch S1 may be implemented as an electronic switch assembly, such as a semiconductor switching circuit, an analog switch integrated circuit, a multiplexer circuit, a crossbar switching circuit, a relay-based switching circuit, or any combination thereof. In embodiments, the processor switch S1 may be implemented as an integrated circuit switch assembly contained in a semiconductor chip, where the integrated circuit switch assembly is configured to switch the shared resources between processors under control of control logic. In embodiments, the control logic may be implemented by the online processor 110, by the primary processor 115, by a separate controller, or by any combination thereof.

In embodiments, the processor switch S1 may be configured to be controlled by the switch S1 control. For example, the switch S1 control may be implemented as a control signal line, a set of control signal lines, a control interface, a control register, a software API, or any combination thereof configured to cause the processor switch S1 to assume a selected switching state. In embodiments, the switch S1 control may be configured to receive user input indicating a selection of the online processor 110 or the primary processor 115. Additionally, or alternatively, in embodiments, the switch S1 control may be configured to receive control input from software executed by the online processor 110 and or software executed by the primary processor 115. For example, in embodiments, software resident in the operating system OS1 and or software resident in the operating system OS2 may be configured to prompt a user to select a desired processing environment and, responsive to the selection, transmit a control signal to the switch S1 control to cause the processor switch S1 to connect the selected processor to the shared resources.

In embodiments, the processor switch S1 may be configured such that a selected processor is connected to the network interface 120 at a given time and another processor is disconnected from at least the network interface 120, which may reduce a likelihood of concurrent exposure of both processors to the Internet 145. In embodiments, such selective connectivity may be configured to reduce a likelihood that a compromise associated with the online processor 110 propagates to the primary processor 115 by limiting shared access to the network interface 120 and by limiting concurrent coupling of both processors to shared peripherals and shared network resources.

FIG. 2 shows a flow diagram illustrating an example operational flow of a computing system 100 configured as a dual-processor system and configured with capabilities and functionality for compartmentalized computing activities through isolated computing environments in accordance with embodiments of the present disclosure. It is noted that the flow diagram of FIG. 2 is provided for purposes of illustration and not by way of limitation, and the particular order, grouping, and arrangement of steps may be modified, combined, reordered, or omitted without departing from the scope of the present disclosure. In embodiments, one or more steps of the flow diagram of FIG. 2 may be implemented by processor-executable instructions stored in memory and executed by at least one of the online processor 110 and the primary processor 115, and in further embodiments, one or more steps may be implemented by control functionality associated with the processor switch S1 and or the switch S1 control.

In embodiments, operation of the flow may begin at step 200 and may proceed to step 202, which may include booting, initializing, or otherwise preparing the computing system 100 for operation. In some embodiments, step 202 may include execution of initialization routines associated with the online processor 110 and or execution of initialization routines associated with the primary processor 115. In embodiments, step 202 may include initialization of the processor switch S1 such that a selected processing environment may be prepared for connection to shared resources.

In embodiments, after boot system, operation may proceed to step 204, which may include presentation of a user interface on the monitor 130 that may be configured to enable selection of an activity type and or selection of a processing environment.

At block 206, an activity may be selected from a menu, which may include receiving user input via the keyboard 132 and or the mouse 134 indicating a type of activity the user intends to perform. In some embodiments, selecting an activity may include selection of routine activity and or selection of restricted activity. In embodiments, after an activity has been selected from the menu at step 206, operation may proceed to step 208, at which an activity and/or type of activity may be selected. For example, step 208 may include selecting, setting, or otherwise controlling the processor switch S1 to connect a selected processor to one or more shared resources. In embodiments, step 208 may include selecting from routine (e.g., online, regular, non-restricted, etc.) activity and restricted (e.g., primary, restricted, protected, etc.) activity. In embodiments, step 208 may include transmitting a control signal via the switch S1 control to cause the processor switch S1 to connect the online processor 110 to the network interface 120, the monitor 130, the keyboard 132, and the mouse 134 (e.g., such as when routine activity is selected). In embodiment, step 208 may include transmitting a control signal via the switch S1 control to cause the processor switch S1 to connect the primary processor 115 to the network interface 120, the monitor 130, the keyboard 132, and the mouse 134 (e.g., such as when restricted activity is selected).

In embodiments, when routine activity is selected, operation may proceed to step 210, which may include receiving user authentication credentials (e.g., a password) associated with the online processor 110. In embodiments, responsive to successful authentication at step 210, operation may proceed to step 212, at which access to the online system is opened. In embodiments, opening access to online system may include enabling access to the online processor 110 and enabling a user session in the operating system OS1. In embodiments, after access to online system has been opened, operation may proceed to step 214, which may include allowing or enabling the user to conduct one or more routine activities using the online processor 110 while the online processor 110 is connected to one or more of the network interface 120, the monitor 130, the keyboard 132, and the mouse 134. In embodiments, when the routine activity is completed, operation may proceed to step 216, which may include determining whether the user intends to return to home screen 204 for selection of another activity or intends to exit operation of the computing system 100.

In embodiments, when restricted activity is selected at step 208, operation may proceed to step 218. At step 218, the user may be prompted or required to enter enhanced authentication information. The enhanced authentication information may include multi-factor authentication, such as requiring a password and a second authentication. In embodiments, the second authentication may include authentication data associated with a second authentication protocol. In embodiments, the second authentication protocol may include a two-factor authentication protocol, a biometric authentication protocol, a hardware token authentication protocol, an out-of-band authentication protocol, or any combination thereof.

In embodiments, responsive to successful authentication at step 218, operation may proceed to step 220, at which access to the primary system is opened, which may include enabling access to the primary processor 115 and enabling a user session in the operating system OS2. In embodiments, after step 220, operation may proceed to step 222, which may include allowing or enabling the user to conduct one or more restricted activities using the primary processor 115 while the primary processor 115 is connected to one or more of the network interface 120, the monitor 130, the keyboard 132, and the mouse 134. In embodiments, when the routine activity is completed, operation may proceed to step 224, which may include determining whether the user intends to return to home screen 204 for selection of another activity or intends to exit operation of the computing system 100.

In embodiments, step 230 may include terminating a user session, shutting down a selected processing environment, shutting down the computing system 100, disconnecting a selected processor from at least the network interface 120, or any combination thereof. In embodiments, the operational flow of FIG. 2 may be configured to enable a user to switch between the online processor 110 and the primary processor 115 while limiting concurrent exposure of both processors to the Internet 145 by controlling the processor switch S1 such that only a selected processor is connected to at least the network interface 120 at a given time.

In embodiments, the dual-processor configuration illustrated in FIG. 1 and FIG. 2 may be configured such that the online processor 110 and the primary processor 115 are associated with different access requirements and different security configurations. In embodiments, such different access requirements and different security configurations may be configured to reduce a likelihood that unauthorized access to the online processor 110 results in unauthorized access to the primary processor 115. In embodiments, the different access requirements and different security configurations may be implemented through one or more access protocols, one or more authentication protocols, one or more encryption protocols, one or more policy controls, or any combination thereof, and such access protocols and security configurations may be implemented in hardware, firmware, software, or any combination thereof.

In embodiments, the online processor 110 may be configured for routine activities and may be accessible by entry of a password (such as at step 210 illustrated in FIG. 2). In embodiments, the online processor 110 may be configured to provide a user experience that is relatively convenient and relatively fast to access, such that routine activities may be performed with minimal friction while still providing at least baseline security. In embodiments, the online processor 110 may be configured with one or more security features, including firewall protection software, malware scanning software, intrusion detection software, or any combination thereof. In embodiments, the online processor 110 may be configured to store user data associated with routine activities within storage accessible to the online processor 110, and in embodiments, such storage may be isolated from storage accessible to the primary processor 115.

In embodiments, the primary processor 115 may be configured for restricted activities and may be accessible by entry of a password and entry of second authentication data (such as at step 218 illustrated in FIG. 2). In embodiments, the second authentication data may include data associated with a two-factor authentication protocol, data associated with a biometric authentication protocol, data associated with a hardware token authentication protocol, data associated with an out-of-band authentication protocol, or any combination thereof. In embodiments, the primary processor 115 may be configured to require stronger authentication than the online processor 110. In embodiments, the primary processor 115 may be configured with one or more additional security features that are not required for the online processor 110, including stronger firewall policies, stronger intrusion detection policies, encryption of data at rest, encryption of data in use, encryption of data in transit, secure boot functionality, integrity checking functionality, or any combination thereof.

In embodiments, the different access requirements and different security configurations of the online processor 110 and the primary processor 115 may be configured to cooperate with the processor switch S1 such that an activity performed on the online processor 110 and an activity performed on the primary processor 115 are separated not only by different authentication requirements, but also by the structural separation provided by the processor switch S1. In embodiments, the processor switch S1 may be configured to ensure that the primary processor 115 is not connected to at least the network interface 120 when the online processor 110 is connected to the network interface 120, and in embodiments, such disconnection may reduce exposure of the primary processor 115 to a compromise associated with the Internet 145. In embodiments, the combination of different access requirements, different security configurations, and selective connectivity through the processor switch S1 may be configured to enable a user to perform routine activities through the online processor 110 while maintaining stronger protections for restricted activities performed through the primary processor 115.

In embodiments, the dual-processor configuration illustrated in FIG. 1 and FIG. 2 is a non-limiting embodiment that is provided to illustrate one example architecture by which separation between routine activity and restricted activity may be achieved through selective switching of shared resources between different processors configured with different operating systems and different access protocols. In embodiments, the dual-processor embodiment is not intended to limit the present disclosure to a system having only two processors, nor is the dual-processor embodiment intended to require any particular hardware arrangement beyond that which is recited in the claims, if any, and as supported by the disclosure herein. In embodiments, the dual-processor embodiment may be understood as one embodiment of the present disclosure.

In embodiments, a modular computing architecture may be provided in which a plurality of computing modules may be provided within a single system. Each of the plurality of computing modules may be configured as a self-contained execution environment including its own processor and memory and may be configured with a designated isolation and security configuration. In embodiments, the modular computing architecture may enable a user to assign different activities to different computing modules, such that a compromise of one activity performed in one computing module is less likely to expose another activity performed in another computing module. In embodiments, the modular computing architecture may implement a tiered configuration of isolation and security such that different computing modules may be configured with different combined isolation and security profiles relative to a host system and relative to other computing modules, as described in further detail with reference to FIG. 3-5.

In embodiments, the processor switch S1 illustrated in FIG. 1 may itself be a scalable switch assembly that may be configured to connect more than two processors to shared resources, such that the dual-processor embodiment may be extended beyond two processors by including additional switching stations and additional processors. In embodiments, the modular computing embodiments described herein may be implemented using switching and selection concepts similar to those illustrated by the processor switch S1, while providing additional flexibility through the use of a host computer 310, a plurality of modules, and a module selector 350 as illustrated in FIG. 3. In embodiments, the dual-processor embodiment and the modular computing embodiments may be combined, such that a computing system may include both a dual-processor subsystem configured to provide a first form of separation and a modular subsystem configured to provide additional separation, wherein such combinations are within the scope of the present disclosure.

FIG. 3 is a block diagram of an exemplary system 300 configured as a modular system and configured with capabilities and functionality for compartmentalized computing activities through isolated computing environments in accordance with embodiments of the present disclosure. In particular embodiments, system 100 may be configured to distribute the computing activities across a plurality of separate computing modules and to control access of the plurality of separate computing modules to shared resources. In embodiments, the system 300 may be configured such that a compromise associated with one activity performed through one computing module is less likely to result in exposure of another activity performed through another computing module, such as by limiting communications between computing modules and by limiting sharing of resources between computing modules. In embodiments, the system 300 may be configured to enable a user to perform, within a single overall computing system, multiple distinct categories of activities having different risk profiles, such as by performing banking activity through the banking module 320, performing social media activity through the social media module 330, and performing general browsing activity through the general use module 340, where each of the banking module 320, the social media module 330, and the general use module 340 may operate as a separate execution environment having its own processor and memory.

It is noted that the description of three modules, and in particular of the banking module 320, the social media module 330, and the general use module 340, is not intended to be limiting in any way. Indeed, more or less modules may be provided, and modules with different risk profiles and for different types or categories of activities may be provided without departing from the spirit of the present disclosure. As such, the description of the banking module 320, the social media module 330, and the general use module 340 should not be construed as limiting in any way.

In embodiments, the system 300 includes a host computer 310. The host computer 310 may be configured as a physical computing platform that houses, supports, and interconnects a plurality of components of the system 300, including the banking module 320, the social media module 330, the general use module 340, the module selector 350, the display 360, the keyboard 362, the mouse 364, and the network 370. In embodiments, the host computer 310 may be configured as a desktop computer, a laptop computer, a workstation, a tablet computing device, a smartphone device, or another computing device.

In embodiments, the host computer 310 may include mechanical structure configured to physically receive one or more modular components, such as by including a chassis, housing, expansion slots, card connectors, backplane connectors, or other physical interface structure configured to accept insertion of a printed circuit board, a card, or another modular component. In embodiments, the host computer 310 may include one or more internal interconnect resources configured to provide electrical connectivity to one or more shared resources, such as one or more buses, one or more interconnect fabrics, one or more peripheral interfaces, one or more storage interfaces, one or more network interfaces, or any combination thereof. In embodiments, the host computer 310 may include, or may be associated with, host resources (e.g., host processor resources, host memory resources, host storage resources, and other resources) that may be separate from module resources.

In embodiments, the system 300 may include a banking module 320, a social media module 330, and a general use module 340. In embodiments, each of the modules may include a processor and/or a memory. In embodiments, the processor included in each of the modules may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of a processor may comprise code segments (e.g., software, firmware, and/or hardware logic) executable in hardware, such as a processor, to perform the tasks and functions described herein. In yet other embodiments, a processor may be implemented as a combination of hardware and software. In some embodiments, the processor may may be communicatively coupled to a memory.

In embodiments, the memory may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. The memory may comprise a processor readable medium configured to store one or more instruction sets (e.g., software, firmware, etc.) which, when executed by a processor (e.g., the processor included in each of the modules), perform tasks and functions as described herein.

In embodiments, the banking module 320 may be configured as a computing module that is configured to support execution of banking activity, financial activity, account management activity, and/or other sensitive or restricted activity that may benefit from higher isolation and stronger security. In embodiments, the banking module 320 may include banking functionality 322 and processor/memory 324. In embodiments, the banking functionality 322 may include one or more software applications, one or more operating system processes, one or more firmware processes, one or more cryptographic processes, or any combination thereof that may be configured to support execution of banking-related activity and other restricted activity.

In embodiments, the processor/memory 324 may include at least one processor operably coupled to at least one memory module, wherein the at least one processor is configured to execute processor-readable instructions stored in the at least one memory module to provide the banking functionality 322. In embodiments, the processor/memory 324 may further be configured to store credentials, cryptographic keys, session tokens, and other sensitive data associated with banking activity in a manner that is inaccessible to other modules, such as by storing such data only within memory spaces accessible to the processor/memory 324.

In embodiments, the banking module 320 may further include, or may be operably coupled to, additional module resources, such as one or more storage resources, one or more cryptographic acceleration resources, one or more secure element resources, one or more authentication resources, or any combination thereof, where such additional module resources may be configured to support higher security operation of the banking module 320.

In embodiments, the banking module 320 may be implemented as a removable and installable card configured to be received by the host computer 310, such as a printed circuit board configured to interface with one or more connectors of the host computer 310, and in embodiments, such interface may be configured to enable communications between the banking module 320 and the module selector 350.

It is noted that the banking module 320 is intended to represent any functionality (not merely banking or financial functionality) or activities of a highly sensitive nature, and that may benefit or may require a highest level of security. The use of “banking” is merely intended as exemplary and not intended to be limiting.

In embodiments, the system 300 includes a social media module 330. In embodiments, the social media module 330 may be configured as a computing module that is configured to support execution of social media activity, general internet activity, messaging activity, and/or other activity that may involve higher exposure to untrusted content and higher exposure to compromise (higher than the banking module 320 activity). In embodiments, the social media module 330 includes social media functionality 332 and processor/memory 334. In embodiments, the social media functionality 332 may include one or more software applications, one or more operating system processes, one or more firmware processes, or any combination thereof configured to support execution of social media related activity, messaging activity, browsing activity, and other routine activity that may involve higher exposure to untrusted content.

In embodiments, the processor/memory 334 may include at least one processor operably coupled to at least one memory module, wherein the at least one processor is configured to execute processor-readable instructions stored in the at least one memory module to provide the social media functionality 332. In embodiments, the social media module 330 may be configured such that data generated, stored, or processed within the processor/memory 334 is not accessible to the banking module 320, and data generated, stored, or processed within the processor/memory 324 is not accessible to the social media module 330, except to the extent that controlled sharing is explicitly enabled by policy and or controlled interfaces described herein.

In embodiments, the social media module 330 may be implemented as a removable and installable card configured to be received by the host computer 310, and in embodiments, the social media module 330 may be configured to rely upon the module selector 350 to access the display 360, the keyboard 362, the mouse 364, and the network 370.

It is noted that the social media module 330 is intended to represent any functionality (not merely social media functionality) or activities of a medium sensitive nature (lower than the banking module 320 activity). The use of “social media” is merely intended as exemplary and not intended to be limiting.

In embodiments, the system 300 includes a general use module 340. In embodiments, the general use module 340 may be configured as a computing module that is configured to support execution of general use activity, routine browsing activity, media activity, email activity, document activity, and/or other routine activity. In embodiments, the general use module 340 includes general use functionality 342 and processor/memory 344. In embodiments, the general use functionality 342 may include one or more software applications, one or more operating system processes, one or more firmware processes, or any combination thereof configured to support execution of general browsing activity, media activity, email activity, document activity, and other routine activity.

In embodiments, the processor/memory 344 may include at least one processor operably coupled to at least one memory module, wherein the at least one processor is configured to execute processor-readable instructions stored in the at least one memory module to provide the general use functionality 342. In embodiments, the general use module 340 may be configured to store routine activity data within memory accessible to the processor/memory 344, and in embodiments, the general use module 340 may be configured such that such routine activity data is inaccessible to the banking module 320 except through controlled interfaces described herein.

In embodiments, the general use module 340 may be implemented as a removable and installable card configured to be received by the host computer 310, and in embodiments, the general use module 340 may be configured to access shared resources through the module selector 350

In embodiments, the functional assignment of the banking module 320, the social media module 330, and the general use module 340 may be fixed, predetermined, and/or pre-configured. For example, in embodiments, the system 300 may be configured such that the banking module 320 is always used for banking activity, the social media module 330 is always used for social media activity, and the general use module 340 is always used for general use activity. In embodiments, the fixed assignment may be configured to reduce user error and reduce accidental mixing of activities across modules. In embodiments, the functional assignment may be stored as policy data, configuration data, and/or user profile data, and the module selector 350 may be configured to enforce the assignment, such as by presenting a menu that maps activity selections to designated modules.

Additionally, or alternatively, in embodiments, the functional assignment may be dynamic, session-based, and or adjustable. For example, in embodiments, a user may decide to assign a particular module to a particular activity for a given session, and later reassign the particular module to a different activity for a later session. In embodiments, the system 300 may be configured to enable a user to select an activity and then select a module to perform the activity. In embodiments, the system 300 may be configured to enable a user to define custom module profiles, where each custom module profile specifies one or more permitted uses for a module and one or more restrictions on use of the module.

In embodiments, the functional assignment described herein is independent from an isolation and security tier assigned to a module. In embodiments, any function may be assigned to any module regardless of whether the module is configured as a higher isolation and higher security module or a lower isolation and lower security module. In embodiments, a user may assign banking activity to the banking module 320 when the banking module 320 is configured with a higher isolation and higher security configuration, but in further embodiments, banking activity may be assigned to another module that is configured with a different isolation and security configuration. Similarly, in embodiments, social media activity may be assigned to the social media module 330 when the social media module 330 is configured with a medium isolation and medium security configuration, but in further embodiments, social media activity may be assigned to a higher isolation and higher security module if a user desires increased protection for that activity. Accordingly, in embodiments, a tier defines a combined isolation and security profile, and a function defines an intended use, and a function does not inherently define or require a particular tier.

In embodiments, the compartmentalization achieved by functional assignment may provide a practical security benefit. For example, in embodiments, a user may perform social media activity through the social media module 330, and if the social media module 330 becomes compromised due to interaction with untrusted content, the banking module 320 may remain protected because the banking module 320 is a separate execution environment with separate processor and memory resources and separate security state. In embodiments, such compartmentalization may reduce a blast radius of a compromise and may reduce a likelihood that a compromise associated with social media activity exposes banking credentials, banking session data, and or other sensitive data associated with the banking module 320.

It is again noted that the banking module 320, the social media module 330, and the general use module 340 are provided as illustrative, non-limiting examples of computing modules that may be assigned to different categories of activities to demonstrate compartmentalization within the system 300. In embodiments, the particular activity labels used herein, including “banking,” “social media,” and “general use,” are used to convey representative examples of activity categories having different sensitivity levels and different risk profiles, and such labels should not be construed as limiting the permitted uses of any computing module. For example, in embodiments, “banking” activity is an illustrative example of a highly sensitive activity category that may involve confidential information, valuable credentials, and high-impact consequences if compromised, and thus “banking” should be understood to include, and to be interchangeable with, other highly sensitive activities, including account management activity, financial activity, tax activity, payroll activity, investment activity, medical records activity, confidential business activity, legal activity, or any other activity that may benefit from stronger isolation and stronger security. Similarly, in embodiments, the term “social media” is used as an illustrative example of a higher exposure activity category that may involve frequent interaction with untrusted content, third-party links, and external communications, and thus “social media” should be understood to include, and to be interchangeable with, other higher exposure activities, including general web browsing, messaging activity, media activity, content consumption activity, or other activities that may be more likely to encounter malicious content. Likewise, in embodiments, the term “general use” is used as an illustrative example of routine computing activities, and such activities may include productivity activity, document activity, email activity, entertainment activity, education activity, or any other general-purpose activity. Accordingly, in embodiments, any computing module may be assigned to any activity category, and the labels used herein are descriptive examples rather than fixed or required assignments.

In embodiments, the system 300 includes a module selector 350. In embodiments, the module selector 350 may be configured to mediate, control, switch, or otherwise manage access of the banking module 320, the social media module 330, and the general use module 340 to one or more shared resources. In embodiments, the shared resources include the display 360, the keyboard 362, the mouse 364, and the network 370. The module selector 350 may be configured such that only one of the banking module 320, the social media module 330, and the general use module 340 is connected to one or more shared resources at a given time. In embodiments, such selective connection may be configured to reduce a likelihood that a compromise associated with one computing module propagates to another computing module through shared resources.

In embodiments, the module selector 350 may be configured to receive selection input from a user and, responsive to the selection input, connect a selected one of the banking module 320, the social media module 330, and the general use module 340 to at least one of the display 360, the keyboard 362, the mouse 364, and the network 370. In some embodiments, the selection input may be received through a user interface presented on the display 360 and controlled using the keyboard 362 and or the mouse 364. Additionally, or alternatively, in embodiments, the module selector 350 may be configured to receive selection input from software executed by one or more of the banking module 320, the social media module 330, and the general use module 340, such as based on policy rules or context detection as described further herein. Additionally, or alternatively, in embodiments, the module selector 350 may be configured to receive selection input from the host computer 310, such as from a control process executed by host resources. In embodiments, the module selector 350 may be implemented as a mechanical switch, an electronic switch, a multiplexer circuit, a crossbar circuit, an integrated circuit switching element, a firmware-controlled selection circuit, or any combination thereof.

In embodiments, the system 300 includes the display 360, the keyboard 362, and the mouse 364. In embodiments, the display 360 may include a monitor, a screen, a touchscreen, and/or another output device configured to present visual output. In embodiments, the keyboard 362 may include a physical keyboard, a virtual keyboard, a touchscreen keyboard, and/or another input device configured to receive user input. In embodiments, the mouse 364 may include a pointing device, a trackpad, a touchscreen input, a stylus input, and/or another pointing interface configured to receive user input. In embodiments, the display 360, the keyboard 362, and the mouse 364 may be shared resources that may be selectively connected to a selected module by the module selector 350. In embodiments, such selective connectivity enables a user to interact with a selected computing module using a common set of peripherals without requiring duplication of such peripherals for each computing module.

In embodiments, the system 300 includes the network 370. In embodiments, the network 370 may include a network connection, a network interface, a wireless connection, a wired connection, a local area network, a wide area network, the Internet, or any combination thereof. In embodiments, the network 370 may be configured to enable communications between a selected computing module and one or more external systems, websites, services, or other network locations. In embodiments, the module selector 350 may be configured to selectively connect a selected computing module to the network 370 such that at least one other computing module is not concurrently connected to the network 370. In embodiments, such selective network connectivity may reduce a likelihood that a compromise associated with one computing module spreads to another computing module through a shared network interface. In embodiments, the module selector 350 may further be configured to enforce restrictions on network access for different computing modules, such as by restricting network access for a higher isolation and higher security module or by restricting which network destinations may be accessed by a selected module.

In embodiments, the components of the system 300 may be configured to interact to provide the overall functionality of compartmentalization of computing activities. For example, during operation, a user may select, via the module selector 350, the social media module 330 to conduct social media activity using the display 360, the keyboard 362, the mouse 364, and the network 370, and thereafter the user may switch to the banking module 320 to conduct banking activity, where the banking activity is conducted within an execution environment separate from the execution environment used for social media activity. Due to the separation of the banking module 320 from the social media module 330, a compromise associated with social media activity is less likely to result in exposure of banking credentials, banking data, or other sensitive information associated with the banking module 320. In embodiments, the system 300 may be configured such that module switching occurs without requiring a user to maintain multiple separate physical devices, while still providing a separation of execution environments and a separation of security risk

In embodiments, each of the banking module 320, the social media module 330, and the general use module 340 may be configured as a respective self-contained execution environment that includes at least a processor and at least a memory, as illustrated by the processor/memory 324, the processor/memory 334, and the processor/memory 344, respectively. In embodiments, a “self-contained execution environment” may include an arrangement in which a computing module includes computing resources configured to execute instructions and store operational state for the computing module, such that the computing module may execute one or more software applications, operating system functions, and/or firmware functions in a manner that is logically separated from other computing modules. In embodiments, the self-contained execution environment may be configured to enable the computing module to receive user input, generate output for presentation to a user, perform network communications, and manage application state, where access to shared resources used to accomplish such operations is controlled through the module selector 350 as described herein.

In embodiments, the isolation between the banking module 320, the social media module 330, and the general use module 340 may be implemented through one or more structural boundaries, one or more logical boundaries, one or more firmware-enforced boundaries, one or more hardware-enforced boundaries, one or more cryptographic boundaries, or any combination thereof. The isolation is not limited to merely presenting different user interfaces for different activities, but instead may include isolation of execution state, isolation of memory state, isolation of storage state, isolation of authentication state, isolation of cryptographic state, isolation of process state, and isolation of network session state, or any combination thereof, such that a compromise that occurs within one module does not automatically provide access to resources of another module.

In embodiments, the banking module 320, the social media module 330, and the general use module 340 may be configured such that there is no direct communication path between modules that bypasses the module selector 350. Such a configuration may include the absence of direct inter-module buses, direct inter-module memory access, direct inter-module storage access, or any combination thereof. In embodiments, when any data sharing between the banking module 320, the social media module 330, and the general use module 340 is permitted, such data sharing may be configured to occur only through a controlled interface, such as through the module selector 350 and or through other mediation functionality described herein, and in embodiments, such controlled interface may enforce one or more policies, filters, authentication requirements, encryption requirements, logging requirements, or any combination thereof prior to permitting any exchange of data. In embodiments, the controlled interface may be configured to block transfer of sensitive data from the banking module 320 to the social media module 330 and or the general use module 340, and in further embodiments, the controlled interface may be configured to block transfer of executable content, scripts, macros, or other potentially harmful content from the social media module 330 and or the general use module 340 into the banking module 320.

In embodiments, the banking module 320, the social media module 330, and the general use module 340 may be configured such that each module maintains its own security domain. In embodiments, a security domain may include one or more authentication credentials, one or more cryptographic keys, one or more encryption policies, one or more firewall policies, one or more application permission policies, one or more access control policies, or any combination thereof. In embodiments, the banking module 320 may maintain banking credentials and cryptographic keys within the banking module 320 such that such banking credentials and cryptographic keys are not accessible to the social media module 330 and are not accessible to the general use module 340. In embodiments, the social media module 330 may maintain social media credentials and session data within the social media module 330 such that such social media credentials and session data are not accessible to the banking module 320 and are not accessible to the general use module 340. In embodiments, the general use module 340 may maintain general use credentials and session data within the general use module 340 such that such general use credentials and session data are not accessible to the banking module 320 and are not accessible to the social media module 330. The separation of credentials and security state may reduce a likelihood that a credential theft event in one module compromises credentials associated with another module.

In embodiments, the isolation between modules may include isolating each of the processor/memory 324, the processor/memory 334, and the processor/memory 344 such that memory content associated with one module is not readable by another module. In embodiments, such isolation may be implemented through separate memory devices, separate memory controllers, separate address spaces, separate page tables, separate encryption domains, separate secure enclaves, or any combination thereof. In embodiments, the isolation may include preventing direct memory access operations by one module into memory ranges allocated to another module. In embodiments, the isolation may include preventing a compromised module from snooping, scanning, or otherwise monitoring memory, storage, or interconnect traffic associated with another module. In embodiments, the isolation may include preventing one module from injecting code, injecting inputs, or injecting commands into another module.

In embodiments, the system 300 may be configured such that the banking module 320, the social media module 330, and the general use module 340 are peers rather than subcomponents of a trusted host. In embodiments, under this peer approach, each module may be configured to execute independently with its own processor and memory and with its own operating environment, and each module may be configured to be selected for use through the module selector 350. In embodiments, the host computer 310 may be configured as a physical platform that supports insertion and interconnection of the modules, but the host computer 310 is not required to be inherently trusted for security purposes with respect to the modules. In embodiments, the host computer 310 may provide mechanical support and electrical backplane support for the modules while still being separated from internal operation of a higher security module. In embodiments, the system 300 may be configured such that a higher security module maintains protection even if the host computer 310 and or other modules are compromised.

In embodiments, the module selector 350 may be configured to cooperate with the banking module 320, the social media module 330, the general use module 340, and the host computer 310 to enforce the isolation described herein. For example, in embodiments, the module selector 350 may be configured such that only one module is connected to the display 360, the keyboard 362, the mouse 364, and the network 370 at a given time, and in embodiments, this may reduce opportunities for cross-module attacks through shared peripherals or shared network interfaces. In embodiments, the module selector 350 may further be configured to enforce restrictions that depend on which module is selected, such as by enforcing stricter network access controls when the banking module 320 is selected and enforcing less strict network access controls when the social media module 330 or the general use module 340 is selected.

In embodiments, the structural and functional relationships described herein with reference to FIG. 3 may enable compartmentalization of activities within a single physical system while reducing risk that compromise spreads between activities. A user may conduct social media activity through the social media module 330, and even if the social media module 330 is compromised, the banking module 320 may remain protected because the banking module 320 is isolated and because the banking module 320 maintains separate processor and memory resources and separate security state. Such compartmentalization is a technical improvement to the functioning of the computing system 300 because it changes the architecture of the computing system 300 from a monolithic shared execution environment to a compartmentalized multi-module execution environment configured to reduce the blast radius of security failures.

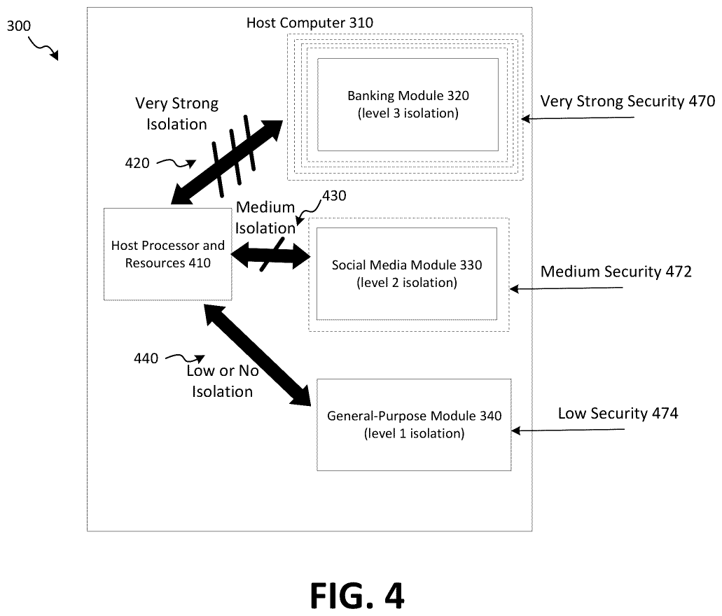

FIG. 4 is a block diagram illustrating the isolation and security configuration of a system configured with capabilities and functionality for compartmentalized computing activities through isolated computing environments in accordance with embodiments of the present disclosure. As shown, the system 300 may be configured such that the banking module 320, the social media module 330, and the general-purpose module 340 may each be configured with a respective isolation and security configuration. In embodiments, the isolation and security configuration may include a tier configuration, a level configuration, and/or a profile configuration, and the tier configuration may define one or more of (i) a degree of isolation of a module relative to other components of the system 300, and (ii) a degree of security implemented for the module, including security features such as authentication requirements, encryption requirements, policy enforcement requirements, and/or other security controls. In embodiments, the tier configuration may be configured to provide an adjustable balance between security and convenience, and between security and cost, such that a module configured with stronger isolation and stronger security may provide increased protection but may involve greater cost and or greater inconvenience, while a module configured with lower isolation and lower security may be less costly and more convenient but may be more vulnerable.

In embodiments, a host computer 310 may include a host processor and resources 410. In embodiments, the host processor and resources 410 may include one or more processors, one or more memory resources, one or more storage resources, one or more bus resources, one or more network resources, and other shared resources that may support operation of the system 300. In embodiments, the host processor and resources 410 may be configured to support operation of the host computer 310 as a physical platform, such as by supporting the module selector 350, providing a user interface environment for module selection, providing drivers for the display 360, the keyboard 362, the mouse 364, and the network 370, and providing other supporting system functions. In embodiments, the host processor and resources 410 may be a shared environment that is exposed to risk associated with general computing activity and network activity, and the tier configurations described herein may be configured to define how strongly each module is separated from the host processor and resources 410 and how strongly each module is protected even if the host processor and resources 410 is compromised.

In embodiments, the tier configuration of a module may define a degree of isolation between the module and the host processor and resources 410, and may further define a degree of isolation between the module and other modules. In embodiments, such isolation may include isolation of execution state, isolation of memory state, isolation of storage state, isolation of authentication state, isolation of cryptographic state, and isolation of network session state. In embodiments, the tier configuration may further define what interfaces are permitted between a module and shared resources, and what interfaces are permitted between a module and the host processor and resources 410. In embodiments, a higher tier may be configured to provide fewer permitted interfaces, more restricted interfaces, and more strongly mediated interfaces, whereas a lower tier may be configured to provide more permitted interfaces and less restrictive interfaces. In embodiments, a higher tier may be configured to reduce or eliminate direct coupling of a module to shared buses, shared memory, shared storage, and other shared resources, whereas a lower tier may allow broader interaction with shared resources.

In embodiments, the tier configuration of a module may also define a degree of security implemented for the module. In embodiments, the degree of security may include authentication requirements, encryption requirements, integrity requirements, policy enforcement requirements, antivirus requirements, intrusion detection systems (IDS) requirements, and/or other security controls. In embodiments, a higher tier module may be configured to require stronger authentication than a lower tier module, such as by requiring multi-factor authentication, biometric authentication, hardware token authentication, and/or other enhanced authentication steps. In embodiments, a higher tier module may be configured to implement stronger encryption than a lower tier module, such as by encrypting data at rest, encrypting data in use, encrypting data in transit, or any combination thereof. In embodiments, a higher tier module may be configured to implement secure boot, integrity checking, tamper detection, audit logging, restricted software installation policies, restricted network destination policies, antivirus protection, and/or other stronger security measures. In embodiments, a lower tier module may be configured with lighter security controls to enable faster access and easier use.

In embodiments, the tier configuration may affect cost, performance, and ease of use. For example, a higher tier module may require additional hardware resources, additional security hardware, additional secure memory resources, additional cryptographic resources, and other additional resources, and such additional resources may increase cost. A higher tier module may further require additional authentication steps, additional verification steps, additional encryption steps, and other additional security steps, and such additional steps may increase inconvenience or reduce ease of use. In embodiments, a lower tier module may require fewer specialized resources and fewer security steps, and may be cheaper and easier to use, but may be more vulnerable. In embodiments, the tier configuration may be configured to provide a tunable system architecture in which highly sensitive activity may be performed within a higher tier module and routine or higher exposure activity may be performed within a lower tier module, allocating stronger protections to the activities that benefit most from such protections.

In embodiments, the banking module 320 may be configured with level 3 isolation and a corresponding very strong isolation configuration 420 and a corresponding very strong security configuration 470. The social media module 330 may be configured with level 2 isolation and a corresponding medium isolation configuration 430 and a corresponding medium security configuration 472. The general-purpose module 340 may be configured with level 1 isolation and a corresponding low or no isolation configuration 440 and a corresponding low security configuration 474. In embodiments, these illustrated assignments are provided as examples to demonstrate that different modules may be configured with different tier configurations, and in embodiments, the particular mapping of a module to a tier may be modified, reassigned, or otherwise changed without departing from the scope of the present disclosure

In embodiments, the system 300 may include a plurality of tier configurations, and each tier configuration may define a combined isolation and security profile for a computing module. In embodiments, the combined isolation and security profile may define how a computing module is separated from the host processor and resources 410 and from other computing modules, and the combined isolation and security profile may further define what security measures are implemented for the computing module to protect the computing module, protect data stored by the computing module, and protect operations performed by the computing module. In embodiments, the combined isolation and security profile may be selected based upon a desired balance between cost, convenience, performance, and protection. In embodiments, the tier configurations described herein may be implemented using structural isolation mechanisms, logical isolation mechanisms, firmware enforcement mechanisms, cryptographic mechanisms, authentication mechanisms, policy enforcement mechanisms, or any combination thereof.

In embodiments, a level 1 isolation and security tier may be associated with the general-purpose module 340. The general-purpose module 340 (level 1 isolation) may be configured with a low or no isolation configuration 440 and a low security configuration 474. The low or no isolation configuration 440 may include a configuration in which the general-purpose module 340 is permitted broader interaction with the host processor and resources 410 than higher tier modules, and in embodiments, the general-purpose module 340 may be permitted to utilize shared resources and shared interfaces with fewer restrictions. In embodiments, the low or no isolation configuration 440 may include permitting the general-purpose module 340 to access shared memory resources, shared storage resources, shared bus resources, and other host resources with fewer isolation boundaries, fewer mediation steps, or fewer access restrictions than higher tier modules. In embodiments, the low security configuration 474 may include a configuration in which the general-purpose module 340 is accessible with relatively lightweight authentication, relatively few access protocol steps, and relatively few security enforcement mechanisms, such as to provide ease of use and lower cost. In embodiments, the general-purpose module 340 may be configured such that a user can quickly access and utilize the general-purpose module 340 for routine activities, and in embodiments, such ease of access may be configured to reduce friction for the user when performing everyday tasks. In embodiments, because the general-purpose module 340 is configured with the low or no isolation configuration 440 and the low security configuration 474, the general-purpose module 340 may be more vulnerable to compromise than a higher tier module, and such vulnerability may be acceptable for certain routine activities, particularly when more sensitive activities are performed within higher tier modules.

In embodiments, a level 2 isolation and security tier may be associated with the social media module 330. In embodiments, the social media module 330 (level 2 isolation) may be configured with a medium isolation configuration 430 and a medium security configuration 472. The medium isolation configuration 430 may include a configuration in which the social media module 330 is separated from the host processor and resources 410 and from other modules with stronger boundaries than the general-purpose module 340, but with less strict boundaries than the banking module 320. In embodiments, the medium isolation configuration 430 may include restricting direct access of the social media module 330 to certain shared resources, restricting direct access to certain host interfaces, restricting access to certain buses, restricting direct access to certain storage resources, restricting direct access to certain memory resources, or any combination thereof. In embodiments, the medium isolation configuration 430 may include requiring mediated access through the module selector 350 for access to shared peripherals and or for access to the network 370, and in embodiments, such mediated access may include enforcement of one or more policies that are more restrictive than policies applied to a level 1 module. In embodiments, the medium security configuration 472 may include a configuration in which the social media module 330 is accessible with stronger authentication and stronger security controls than the general-purpose module 340, while still maintaining a user experience that is less restrictive and less burdensome than a level 3 module. In embodiments, the medium security configuration 472 may include use of multi-factor authentication in some cases, use of encryption for certain data in some cases, use of stronger malware protections, use of stricter application controls, use of more restricted network destination controls, or any combination thereof, while still permitting a relatively convenient user experience for activities that may involve frequent user interactions. In embodiments, the social media module 330 may be configured for activities that have higher exposure to untrusted content, and as such, the social media module 330 may be configured with more protection than a level 1 module to reduce a likelihood that compromise propagates to higher tier modules.

In embodiments, a level 3 isolation and security tier may be associated with the banking module 320. In embodiments, the banking module 320 (level 3 isolation) may be configured with a very strong isolation configuration 420 and a very strong security configuration 470. The very strong isolation configuration 420 may include a configuration in which the banking module 320 is strongly separated from the host processor and resources 410 and from other modules such that compromise of the host processor and resources 410 and or compromise of another module does not provide access to the banking module 320. In embodiments, the very strong isolation configuration 420 may include eliminating direct access paths between the banking module 320 and shared resources, eliminating direct access paths between the banking module 320 and host interfaces, eliminating direct access paths between the banking module 320 and shared buses, and limiting permitted communications to a minimal set of controlled interfaces. In embodiments, such controlled interfaces may be configured to enforce filtering, validation, policy enforcement, and or one-way communication restrictions. In embodiments, the very strong isolation configuration 420 may include isolating memory resources of the banking module 320 from other modules and from the host processor and resources 410, isolating storage resources of the banking module 320 from other modules and from the host processor and resources 410, and isolating cryptographic resources of the banking module 320 from other modules and from the host processor and resources 410. In embodiments, the very strong security configuration 470 may include stronger authentication requirements and stronger security enforcement than lower tiers. In embodiments, the very strong security configuration 470 may include multi-factor authentication, biometric authentication, hardware token authentication, secure boot, integrity checking, cryptographic key protection, encryption of data at rest, encryption of data in use, encryption of data in transit, strict application installation restrictions, strict network destination restrictions, strict logging and auditing requirements, or any combination thereof. In embodiments, the banking module 320 may be configured such that accessing the banking module 320 may require more user steps, more authentication steps, and more security checks than accessing a lower tier module, but the result may be substantially improved protection for highly sensitive activities.

As noted, the tier configurations described herein may be configured to provide explicit tradeoffs between cost, convenience, and protection. For example, configuring a module to operate at a higher tier may require additional hardware resources, such as additional secure memory resources, additional cryptographic acceleration resources, additional secure enclaves, additional isolation circuitry, additional switching circuitry, and other resources, and such additional resources may increase cost of manufacturing and cost of deployment. Configuring a module to operate at a higher tier may further require additional software resources, additional firmware resources, and additional policy enforcement resources, and such additional resources may increase cost and complexity. Configuring a module to operate at a higher tier may further increase inconvenience for a user, such as by requiring additional authentication steps, requiring additional confirmation steps, requiring additional secure session establishment steps, and reducing the ability to quickly switch between activities. Configuring a module to operate at a lower tier may reduce cost and may improve convenience, but may expose the module to greater risk. In embodiments, these tradeoffs are intentional and are configured to allow a system designer or a user to allocate stronger protections to activities that benefit most from such protections while allowing routine activities to be performed efficiently and conveniently.

In embodiments, tier configurations may be selectable, configurable, and or adjustable. In embodiments, a user may decide to configure the banking module 320 as a level 3 module and configure the social media module 330 as a level 2 module and configure the general-purpose module 340 as a level 1 module to create a system in which the most sensitive activity is protected with the strongest isolation and strongest security. In embodiments, a system policy may define such tier assignments. In embodiments, the module selector 350 and or other controller functionality may be configured to enforce the tier assignments by restricting interfaces, enforcing authentication requirements, enforcing encryption requirements, enforcing policy requirements, and other security measures associated with the tier assignments. In embodiments, the tier assignments may be modified over time, such as to elevate a module to a higher tier in response to detection of a sensitive activity, to elevate a module to a higher tier in response to detection of elevated risk, or to lower a module to a lower tier when high security is not required.

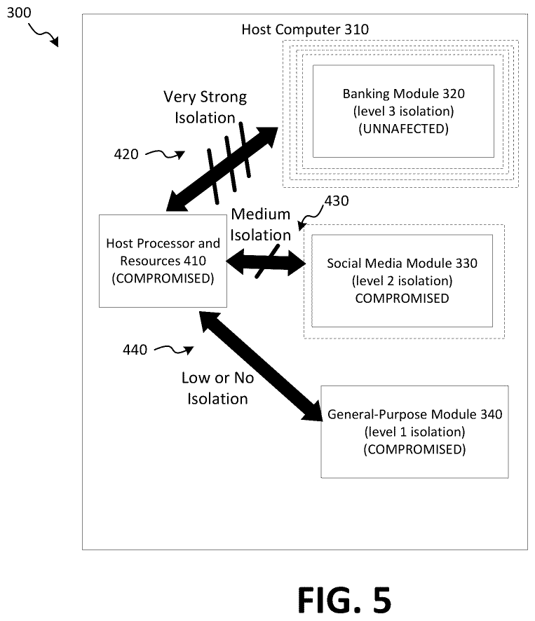

FIG. 5 is a block diagram illustrating an example operational scenario of a system configured with capabilities and functionality for compartmentalized computing activities through isolated computing environments in accordance with embodiments of the present disclosure. As shown, the system 300 is illustrated in an example operational scenario in which at least a portion of the system 300 has become compromised, while a higher tier computing module remains protected. This example is provided to illustrate a non-limiting example state of operation of the system 300 and to illustrate a technical effect achieved by the tiered isolation and security configurations described herein. The example scenario of FIG. 5 demonstrates that the system 300 may be configured such that a compromise occurring in a lower tier portion of the system 300 does not necessarily propagate into a higher tier computing module, even when the lower tier portion of the system 300 includes the host processor and resources 410.

As shown, the host processor and resources 410 may be compromised. For example, the host processor and resources 410 may become compromised due to interaction with untrusted network content, execution of malicious code, installation of malware, exploitation of software vulnerabilities, exploitation of firmware vulnerabilities, exploitation of driver vulnerabilities, exploitation of peripheral interfaces, exploitation of network interfaces, or any combination thereof. In embodiments, compromise of the host processor and resources 410 may include unauthorized execution of code within host processes, unauthorized access to host memory, unauthorized access to host storage, unauthorized modification of host configuration settings, unauthorized access to system credentials stored by the host processor and resources 410, unauthorized monitoring of host network traffic, unauthorized interception of host input events, or any combination thereof. In embodiments, compromise of the host processor and resources 410 is representative of a high impact compromise because the host processor and resources 410 may be a shared environment that supports at least some portions of the system 300, and as such, this scenario shows how the system may maintain protection of a higher tier computing module even when the host processor and resources 410 is compromised.

As shown, the general-purpose module 340 may be compromised and the social media module 330 may be compromised. The general-purpose module 340 is illustrated as a level 1 isolation module and the social media module 330 is illustrated as a level 2 isolation module. In embodiments, the compromise of the general-purpose module 340 and the compromise of the social media module 330 may occur independently, or the compromise of one of the general-purpose module 340 and the social media module 330 may facilitate compromise of the other, such as through interactions with the host processor and resources 410, through interactions with shared resources, through common network exposure, through user actions, or any combination thereof. The compromise state shown in FIG. 5 may be representative of a real-world situation in which a user performs higher exposure activities, such as activities involving frequent contact with untrusted content, and such activities result in compromise of the system as a whole.

As also shown, the banking module 320 is shown as unaffected. The banking module 320 is illustrated as a level 3 isolation module, and the banking module 320 is further associated with a very strong isolation configuration 420 and a very strong security configuration as described herein. In embodiments, the banking module 320 may remain unaffected even while the host processor and resources 410 is compromised and even while the general-purpose module 340 and the social media module 330 are compromised because the banking module 320 is configured to be separated from the host processor and resources 410 and separated from other modules by stronger isolation boundaries and stronger security controls than are used for lower tier modules. In embodiments, being unaffected may include that banking credentials stored within the banking module 320 remain inaccessible to the compromised components, banking session data stored within the banking module 320 remains inaccessible to the compromised components, cryptographic keys stored within the banking module 320 remain inaccessible to the compromised components, and banking operations performed within the banking module 320 remain resistant to interference by the compromised components.

In embodiments, the protection of the banking module 320 shown in FIG. 5 may result from a combination of structural separation and security enforcement as described herein. In embodiments, the structural separation may include isolating memory resources of the banking module 320 from memory resources of the host processor and resources 410 and from memory resources of other modules, isolating storage resources of the banking module 320 from storage resources of the host processor and resources 410 and from storage resources of other modules, and isolating execution state of the banking module 320 from execution state of the host processor and resources 410 and from execution state of other modules. In embodiments, the structural separation may include limiting permitted interfaces between the banking module 320 and the host processor and resources 410, limiting permitted interfaces between the banking module 320 and other modules, and requiring that communications, if any, occur only through controlled interfaces subject to policy enforcement. In embodiments, the structural separation may include preventing direct memory access from the host processor and resources 410 into memory spaces allocated to the banking module 320, preventing direct bus access from the host processor and resources 410 into bus resources allocated to the banking module 320, and preventing direct storage access from the host processor and resources 410 into storage resources allocated to the banking module 320. In embodiments, the structural separation may include a configuration in which the banking module 320 maintains a separate security domain, a separate encryption domain, and a separate authentication domain, such that credentials and cryptographic materials of the banking module 320 are not shared with, and are not readable by, lower tier environments.

In embodiments, the security enforcement associated with the banking module 320 may include stronger authentication, stronger encryption, stronger integrity checking, and stronger policy restrictions than are implemented for lower tier modules. In embodiments, stronger authentication may include requiring multi-factor authentication, biometric authentication, hardware token authentication, and or other enhanced authentication protocols prior to permitting access to the banking module 320 and or prior to permitting access to sensitive functions of the banking module 320. In embodiments, stronger encryption may include encrypting data stored by the banking module 320, encrypting data processed by the banking module 320, encrypting communications associated with the banking module 320, or any combination thereof, such that even if the host processor and resources 410 is compromised, the compromised host processor and resources 410 does not have access to the cryptographic keys needed to decrypt such data. In embodiments, stronger policy restrictions may include restricting which applications may execute within the banking module 320, restricting which network destinations may be accessed by the banking module 320, restricting installation of software within the banking module 320, requiring integrity verification of software executed within the banking module 320, and requiring logging and auditing of access attempts directed to the banking module 320.

In embodiments, the compromise containment shown in FIG. 5 may be understood as a reduction in blast radius. In embodiments, the system 300 may be configured such that even when a compromise occurs in a module configured with a low isolation and low security profile, and even when a compromise occurs in a module configured with a medium isolation and medium security profile, and even when the host processor and resources 410 is compromised, the compromise is contained to those compromised environments and does not inherently provide access to the banking module 320. In embodiments, this containment is a technical improvement to the functioning of the system 300 because it changes the security consequences of compromise from a system-wide failure to a compartmentalized failure in which one compartment may fail while another compartment remains protected.

In embodiments, the scenario of FIG. 5 further illustrates a practical benefit of assigning highly sensitive activities to a higher tier computing module. A user may perform a higher exposure activity through the social media module 330 and or the general-purpose module 340, and if such activity results in compromise of the social media module 330 and or the general-purpose module 340, the user may still perform a highly sensitive activity through the banking module 320 with reduced risk that the highly sensitive activity is exposed. In embodiments, this benefit is achieved not merely by selecting different applications, but by selecting different computing modules having different combined isolation and security configurations.

In embodiments, the system 300 may include automatic module selection and context awareness functionality. In embodiments, the automatic module selection and context awareness functionality may be configured to reduce reliance on a user to manually select the appropriate module for a given activity and may be configured to reduce a likelihood that a user unintentionally performs a sensitive activity within a lower tier module. In embodiments, the automatic module selection and context awareness functionality may be configured to detect a type of activity being performed or about to be performed, and responsive to such detection, cause selection of a particular computing module and or cause selection of a particular tier configuration. For example, in embodiments, the system 300 may be configured to detect that a user is navigating to a banking website, entering financial credentials, launching a financial application, accessing a confidential account portal, or performing another highly sensitive activity, and responsive to such detection, the system 300 may be configured to cause the banking module 320 to be selected by the module selector 350 and or cause a higher isolation and security configuration to be applied. In embodiments, the system 300 may be configured to detect that a user is accessing social media content, opening third-party links, accessing streaming media, or performing another higher exposure activity, and responsive to such detection, the system 300 may be configured to select the social media module 330 or the general-purpose module 340. In embodiments, the system 300 may be configured to present a prompt to the user to confirm or override an automatically selected module, and in further embodiments, the system 300 may be configured to enforce automatic selection without user override based upon a policy configuration, a compliance configuration, or an administrator configuration.

In embodiments, the automatic module selection and context awareness functionality may be implemented using artificial intelligence functionality. In embodiments, the artificial intelligence functionality may include one or more models, one or more classifiers, one or more rules engines, or any combination thereof configured to infer an activity type, infer an activity sensitivity level, infer a risk level, or infer an appropriate tier configuration based upon contextual signals. In embodiments, the contextual signals may include one or more of a network destination, a uniform resource locator, an application identifier, user interface content, detected credential entry events, process behavior, network traffic characteristics, historical user behavior, administrator policy data, or any combination thereof. In embodiments, the artificial intelligence functionality may be configured to generate a selection decision indicating a recommended computing module and/or a recommended tier configuration, and the system 300 may be configured to cause the module selector 350 to select the recommended computing module and or to cause application of the recommended tier configuration. In embodiments, the artificial intelligence functionality may be implemented locally within the host computer 310, within a computing module, within a dedicated security processor, within a secure enclave, within a remote server, or any combination thereof, and in embodiments, the artificial intelligence functionality may be configured to operate in real time or near real time to adjust module selection as user activity changes.

In embodiments, the system 300 may be implemented in a variety of implementation variations. In embodiments, the banking module 320, the social media module 330, and the general-purpose module 340 may be implemented as plug-in modules, cards, or printed circuit boards installable within the host computer 310, and in other embodiments, one or more of such modules may be implemented as a system-on-chip partition, as a secure enclave, as a dedicated security processor subsystem, or as another hardware-based execution environment. In embodiments, the module selector 350 may be implemented in hardware, in firmware, in software, or as a hybrid combination thereof, and in embodiments, the module selector 350 may be configured to enforce isolation and security through switching circuitry, multiplexing circuitry, crossbar circuitry, firmware policy enforcement, software policy enforcement, or any combination thereof. In embodiments, the system 300 may be implemented in a desktop computer, a laptop computer, a mobile device, a workstation, and or another computing device, and in embodiments, the system 300 may be configured for use in consumer environments, enterprise environments, and regulated or high-security environments in which compartmentalization of activities is beneficial.

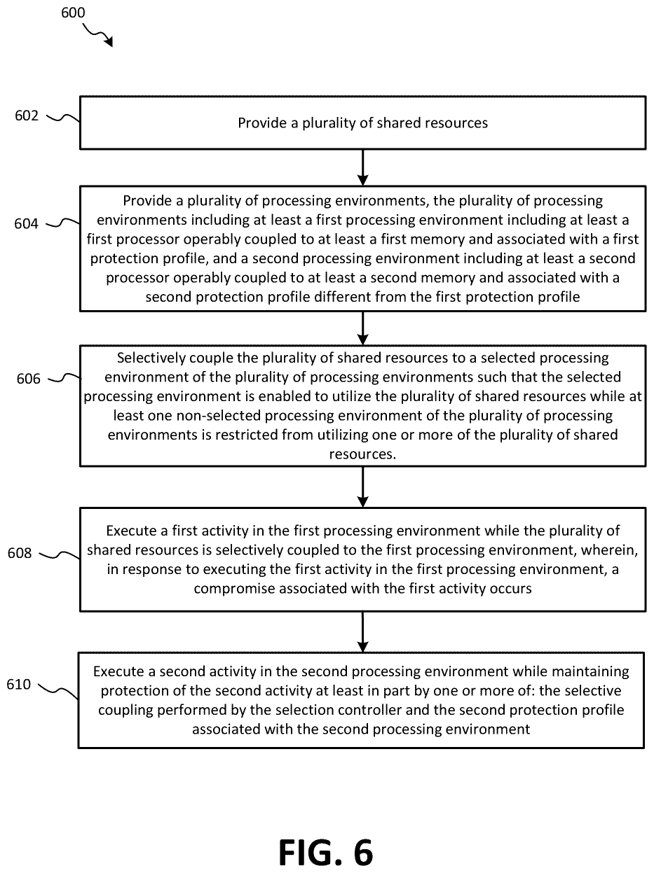

FIG. 6 shows a high-level flow diagram 600 of operation of a system configured for reducing propagation of a compromise between different computing activities in accordance with embodiments of the present disclosure. For example, the functions illustrated in the example blocks shown in FIG. 6 may be performed by systems 100 or 300 of FIGS. 1-5, according to embodiments herein. In embodiments, the operations of the method 600 may be stored as instructions that, when executed by one or more processors, cause the one or more processors to perform the operations of the method 600.

At block 602, one or more container identification detections generated by one or more automated data collection systems are received. In embodiments, the one or more automated data collection systems may include one or more air-based systems 150 and one or more ground-based systems 155 operating within a container yard. In embodiments, functionality of an ingestion manager (e.g., ingestion manager 120 as illustrated in FIGS. 1 and 2) may be used to receive the one or more container identification detections generated by the one or more automated data collection systems. In embodiments, the ingestion manager 120 may perform operations to receive the one or more container identification detections according to operations and functionality as described above with reference to ingestion manager 120 and as illustrated in FIGS. 1-3.

At block 602, a plurality of shared resources is provided. In embodiments, the plurality of shared resources may include one or more of: a display resource, an input resource, and a network interface resource. In embodiments, the plurality of shared resources may include a display resource configured to provide visual output, an input resource configured to receive user input, and a network interface resource configured to enable network communications. In embodiments, the plurality of shared resources may correspond to, or may include, at least the monitor 130, the keyboard 132, the mouse 134, and the network interface 120 of FIG. 1, and or the display 360, the keyboard 362, the mouse 364, and the network 370 of FIG. 3, although other shared resources may also be included.

At block 604, a plurality of processing environments is provided. In embodiments, the plurality of processing environments includes at least a first processing environment including at least a first processor operably coupled to at least a first memory and associated with a first protection profile, and a second processing environment including at least a second processor operably coupled to at least a second memory and associated with a second protection profile different from the first protection profile. In embodiments, each of the first protection profile and the second protection profile may include one or more of: an isolation profile and a security profile. In embodiments, the first processing environment and the second processing environment may be implemented as an online processor (e.g., online processor 110 as shown in FIG. 1) and a primary processor (e.g., primary processor 115 as shown in FIG. 1), respectively. Additionally, or alternatively, in embodiments, the first processing environment and the second processing environment may be implemented as computing modules, including one or more of the banking module 320, the social media module 330, and the general-purpose module 340, respectively. In embodiments, the first protection profile and the second protection profile may differ by one or more security controls, including one or more of authentication requirements, encryption requirements, policy enforcement requirements, and other security controls, and the first protection profile and the second protection profile may further differ by one or more isolation controls, including one or more of isolation boundaries, restricted interfaces, mediated interfaces, and other isolation controls.

At block 606, the plurality of shared resources is selectively coupled to a selected processing environment of the plurality of processing environments such that the selected processing environment is enabled to utilize the plurality of shared resources while at least one non-selected processing environment of the plurality of processing environments is restricted from utilizing one or more of the plurality of shared resources. In embodiments, selective coupling may be performed by a selection controller configured to switch connectivity of one or more shared resources between processing environments. In embodiments, functionality of a selection controller (e.g., processor switch S1 as illustrated in FIG. 1 and/or the module selector 350 as illustrated in FIG. 3) may be used to selectively couple the plurality of shared resources to a selected processing environment of the plurality of processing environments. In embodiments, the selection controller may perform operations to selectively couple the plurality of shared resources to a selected processing environment of the plurality of processing environments according to operations and functionality as described above with reference to processor switch S1 and/or the module selector 350 and as illustrated in FIGS. 1-5.

In embodiments, selectively coupling the plurality of shared resources to a selected processing environment of the plurality of processing environments such that the selected processing environment is enabled to utilize the plurality of shared resources while at least one non-selected processing environment of the plurality of processing environments is restricted from utilizing one or more of the plurality of shared resources may include generating and/or sending (manually or automatically) a control signal to the selection controller to cause the selection controller to physically (e.g., mechanically or electrically) connect or couple the plurality of shared resources to the selected processing environment while at least one non-selected processing environment of the plurality of processing environments is restricted from utilizing one or more of the plurality of shared resources. In embodiments, this may include actuating a switch, a relay, an electronic switch or relay, and/or any other mechanism configured to enable the coupling or connection to the plurality or resources.

At block 608, a first activity is executed in the first processing environment while the plurality of shared resources is selectively coupled to the first processing environment. In embodiments, in response to executing the first activity in the first processing environment, a compromise associated with the first activity occurs. In embodiments, the first activity may include a higher exposure activity, such as social media activity, routine browsing activity, or other activity involving interaction with untrusted content, although other activities may also be included. In embodiments, the compromise may include unauthorized execution of code, unauthorized access to data, installation of malware, credential theft, network interception, or other security events. In embodiments, the occurrence of the compromise is not required to be detected, identified, confirmed, or otherwise recognized by the system.

At block 610, a second activity is executed in the second processing environment while maintaining protection of the second activity at least in part by one or more of: the selective coupling performed by the selection controller and the second protection profile associated with the second processing environment. In embodiments, the second activity may include a highly sensitive activity, such as banking activity, account management activity, confidential business activity, or other restricted activity, although other activities may also be included. In embodiments, maintaining protection of the second activity may include maintaining confidentiality of credentials, session data, cryptographic keys, and other sensitive data associated with the second processing environment. In embodiments, maintaining protection of the second activity may include preventing the compromise associated with the first activity from providing unauthorized access to the second processing environment, such as by maintaining an isolation boundary between the first processing environment and the second processing environment and by implementing one or more security controls in the second protection profile, including one or more of enhanced authentication requirements and encryption requirements.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims, if any.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements, if any, unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims, if any. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims, if any. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims, if any, are intended to include within their scope such processes, machines, manufacture, compositions of matter, means, methods, or steps.

What is claimed is:

1. A system for reducing propagation of a compromise between different computing activities, the system comprising:
a plurality of shared resources;
a plurality of processing environments, the plurality of processing environments comprising at least a first processing environment including at least a first processor operably coupled to at least a first memory, and a second processing environment including at least a second processor operably coupled to at least a second memory; and
a selection controller operably coupled to the plurality of shared resources and to the plurality of processing environments, wherein the selection controller is configured to selectively couple the plurality of shared resources to a selected processing environment of the plurality of processing environments such that the selected processing environment is enabled to utilize the plurality of shared resources while at least one non-selected processing environment of the plurality of processing environments is restricted from utilizing one or more of the plurality of shared resources,
wherein the plurality of processing environments is configured to be associated with different protection profiles relative to at least one other processing environment of the plurality of processing environments, such that a first protection profile associated with the first processing environment is different from a second protection profile associated with the second processing environment, and
wherein the system is configured such that, responsive to a compromise associated with a first activity executed in the first processing environment of the plurality of processing environments, execution of a second activity in a second processing environment of the plurality of processing environments remains protected at least in part by the selective coupling performed by the selection controller and by the different protection profiles of the plurality of processing environments.

2. The system of claim 1, wherein the different protection profiles include one or more of: different security profiles and different isolation profiles.

3. The system of claim 2, wherein the different security profiles include at least one difference between the first processing environment and the second processing environment in one or more of:
an authentication requirement for accessing the respective processing environment;
an access protocol required to enable the respective processing environment to utilize the plurality of shared resources;
an encryption requirement for protecting data associated with the respective processing environment;
a policy restricting installation or execution of software within the respective processing environment; and
a policy restricting network destinations accessible by the respective processing environment.

4. The system of claim 2, wherein the different isolation profiles include at least one difference between the first processing environment and the second processing environment in one or more of:
whether the respective processing environment is permitted direct access to at least one host resource of the computing system;
whether communications between the respective processing environment and the plurality of shared resources are required to be mediated by the selection controller;
whether the respective processing environment is permitted direct communication with another processing environment of the plurality of processing environments; and
whether memory resources associated with the respective processing environment are isolated from memory resources associated with another processing environment of the plurality of processing environments.

5. The system of claim 1, wherein the different protection profiles include at least one difference in an isolation boundary enforced between the first processing environment and at least one of the second processing environment or at least one host resource of the computing system, and the different protection profiles further include at least one difference in a security control implemented for the first processing environment relative to the second processing environment, the security control comprising at least one of an authentication requirement or an encryption requirement.

6. The system of claim 1, wherein the plurality of shared resources includes at least:
a display resource, an input resource, and a network interface resource.

7. The system of claim 1, wherein the selection controller includes a switch assembly configured to synchronously switch a plurality of conductors associated with the plurality of shared resources between the first processing environment and the second processing environment.

8. The system of claim 1, wherein the plurality of processing environments includes at least a third processing environment including at least a third processor operably coupled to at least a third memory, and wherein the selection controller is configured to selectively couple the plurality of shared resources to a selected processing environment of the first processing environment, the second processing environment, and the third processing environment.

9. The system of claim 1, wherein the selection controller is configured to:
receive an activity selection indicating the first activity or the second activity; and
select the selected processing environment based at least in part on the activity selection.

10. The system of claim 9, wherein the selection controller is configured to select the selected processing environment based at least in part on context awareness information indicative of a type of activity, and wherein the context awareness information is generated using artificial intelligence functionality.

11. A method of reducing propagation of a compromise between different computing activities, the method comprising:
providing a plurality of shared resources;
providing a plurality of processing environments, the plurality of processing environments including at least a first processing environment including at least a first processor operably coupled to at least a first memory and associated with a first protection profile, and a second processing environment including at least a second processor operably coupled to at least a second memory and associated with a second protection profile different from the first protection profile;
selectively coupling the plurality of shared resources to a selected processing environment of the plurality of processing environments such that the selected processing environment is enabled to utilize the plurality of shared resources while at least one non-selected processing environment of the plurality of processing environments is restricted from utilizing one or more of the plurality of shared resources;
executing a first activity in the first processing environment while the plurality of shared resources is selectively coupled to the first processing environment, wherein, in response to executing the first activity in the first processing environment, a compromise associated with the first activity occurs; and
executing a second activity in the second processing environment while maintaining protection of the second activity at least in part by one or more of: the selective coupling performed by the selection controller and the second protection profile associated with the second processing environment.

12. The method of claim 11, wherein providing the plurality of shared resources includes providing at least a display resource, an input resource, and a network interface resource.

13. The method of claim 11, wherein selectively coupling the plurality of shared resources includes selectively coupling the network interface resource to the selected processing environment such that the at least one non-selected processing environment is disconnected from the network interface resource.

14. The method of claim 11, wherein the first protection profile and the second protection profile include one or more of: different security profiles and different isolation profiles.

15. The method of claim 14, wherein the different security profiles include at least one difference between the first processing environment and the second processing environment in one or more of:
an authentication requirement for accessing the respective processing environment;
an access protocol required to enable the respective processing environment to utilize the plurality of shared resources;
an encryption requirement for protecting data associated with the respective processing environment;
a policy restricting installation or execution of software within the respective processing environment; and
a policy restricting network destinations accessible by the respective processing environment.

16. The method of claim 14, wherein the different isolation profiles include at least one difference between the first processing environment and the second processing environment in one or more of:
whether the respective processing environment is permitted direct access to at least one host resource of the computing system;
whether communications between the respective processing environment and the plurality of shared resources are required to be mediated by the selection controller;
whether the respective processing environment is permitted direct communication with another processing environment of the plurality of processing environments; and
whether memory resources associated with the respective processing environment are isolated from memory resources associated with another processing environment of the plurality of processing environments.

17. The method of claim 11, wherein selectively coupling the plurality of shared resources includes synchronously switching, using a switch assembly of the selection controller, a plurality of conductors associated with the plurality of shared resources between the first processing environment and the second processing environment.

18. The method of claim 11, further comprising:
providing at least a third processing environment including at least a third processor operably coupled to at least a third memory, and selectively coupling the plurality of shared resources to a selected processing environment of the first processing environment, the second processing environment, and the third processing environment.

19. The method of claim 11, further comprising:
receiving an activity selection indicating the first activity or the second activity, and selecting the selected processing environment based at least in part on the activity selection.

20. The method of claim 19, further comprising:
generating context awareness information indicative of a type of activity using artificial intelligence functionality, and selecting the selected processing environment based at least in part on the context awareness information.
